(19) United States
(12) Patent Application Publication
(10) Pub. No.: US 2011/0212307 A1
(43) Pub. Date: Sep. 1, 2011

(54) METHOD TO DECREASE WARPAGE OF A MULTI-LAYER SUBSTRATE AND STRUCTURE THEREOF

(75) Inventor: Chih-kuang Yang, Hsin-Chu City (TW)

(73) Assignee: PRINCO CORP., Hsinchu (TW)

(21) Appl. No.: 13/104,293

(22) Filed: May 10, 2011

Related U.S. Application Data
(63) Continuation-in-part of application No. 12/207,685, filed on Sep. 10, 2008, now abandoned.

(30) Foreign Application Priority Data
Feb. 18, 2008 (TW) 097105644

(51) Int. Cl. B32B 3/00

(52) U.S. Cl. 428/189

(57) ABSTRACT

Disclosed is a method to decrease warpage of a multi-layer substrate, comprises a plurality of metal layers and a plurality of dielectric layers, which are alternately formed. A plane parallel with a first metal layer and a second metal layer of the plurality of metal layers substantially has the same distance between the first metal layer and the second metal layer respectively. The plane is defined as a central plane between the first metal layer and the second metal layer. A first total area covered by metal in the first metal layer is larger than a second area covered by metal in the second metal layer. At least one redundant metal is further set in same layer of the second metal layer. A second total area comprising a redundant metal area covered by the redundant metal and the second area is considerably equivalent to the first total area.

### CROSS REFERENCE TO RELATED APPLICATION

This application is a continuation-in-part of prior application Ser. No. 12/207,685, filed Sep. 10, 2008.

### BACKGROUND OF THE INVENTION

1. Field of the Invention

The present invention generally relates to a method to decrease warpage of a multi-layer substrate, and more particularly to a method of balancing stress in a flexible multi-layer substrate to decrease warpage or twist of the multi-layer substrate and improve a heat dissipation efficiency of a multilayer substrate.

2. Description of Prior Art

A multi-layer substrate today may employ coating method to form a plurality of dielectric layers and corresponding metal layers between these dielectric layers are formed by lithography process. The aforesaid dielectric layers and metal layers are alternately stacked-up to realize the aforementioned multi-layer substrate having advantage of thin thickness and simple materials. Moreover, such coating method can be significantly suitable for manufacturing flexible multi-layer substrate.

Generally, miniaturization of all electronics products is an unavoidable trend in this modern world. With continuous rapid development of the IC industry along with Moore's Law, the heat dissipation for chips also become an important issue as considering the package technology thereof. As mentioning a consumer electronics product, the thermal flux density can be 10 W/sqcm. For a CPU, the thermal flux density can be much higher and even reach up to 100 W/sqcm. However, the said numbers of thermal flux densities also increases up fast with the miniaturization trend grows. Therefore, any improvement of the heat dissipation efficiency for the IC and the package thereof become significantly useful and important for the related electronics products, particularly for a mobile electronics device which cannot be installed with fans and even the heat dissipation module has to be minimized for the portability. An interior solution in the package multi-layer substrate but no additional heat dissipation module becomes a need.

Moreover, the wet films were formed by the dielectric layers coating method, therefore, the steps of drying these dielectric layers to be hardened thereof, are needed hereafter. Different metal layers have different areas and different locations because of respective circuit designs. Accordingly, dielectric layers corresponding to different metal layers may have different areas, also. After the metal layers and the dielectric layers are stacked-up and the aforesaid drying and hardening process are proceeded, shrinkage rates of respective dielectric layers may be different (although all dielectric layers' materials are the same, the shrinkage rates can be different due to respective shapes, occupied areas and volumes). Consequently, stresses become unbalanced between some metal layers and some dielectric layers to result in warpage or twist of the multi-layer substrate. Even the dielectric layers that are not formed by the coating method, unbalanced stress can cause warpage or twist of the multi-layer substrate that happens because of different volumes, thicknesses materials, or constructions of different metal layers and dielectric layers.

The aforesaid warpage or twist can seriously influence precision of whole system assembly later on, even prevent assembly the whole system. Furthermore, speaking of design application of a flexible multi-layer substrate, foldable characteristic is the major purpose of developing the flexible multi-layer substrate industry. After the flexible multi-layer substrate which becomes thinner and thinner is applied into productions, some specific areas, even the entire substrate can be bent frequently. If the stress, warpage or twist problems of the multi-layer substrate are not solved, the lifetime of the production can be shorter and cannot be commercialized.

### SUMMARY OF THE INVENTION

An objective of the present invention is to provide a method of forming a multi-layer substrate which is capable of improving a heat dissipation efficiency thereof.

Another objective of the present invention is to provide a method to decrease warpage of a multi-layer substrate by balancing a stress generated by differences of the occupied area and the location of different metal layers and dielectric layers in a flexible multi-layer substrate.

For accomplishing aforesaid objective of the present invention, the multi-layer substrate structure comprises a plurality of metal layers and a plurality of dielectric layers, which are alternately formed in the multi-layer substrate structure. A plane parallel with a first metal layer and a second metal layer of the plurality of metal layers substantially has the same distance between the first metal layer and the second metal layer respectively. The plane is defined as a central plane between the first metal layer and the second metal layer. A first total area covered by metal in the first metal layer is larger than a second area covered by metal in the second metal layer. At least one redundant metal is further set in same layer of the second metal layer. A second total area comprising a redundant metal area covered by the redundant metal and the second area is considerably equivalent to the first total area.

Significantly, by adding redundant metals to the dielectric layers according to the present invention, the heat dissipation efficiency of the multi-layer substrate can be improved. The thermal flux of the IC chip packaged with the multi-layer substrate can be conducted therethrough with better efficiency. The temperature of the IC chip can be cooled down. Therefore, further miniaturization for the mobile electronics device can be realized.

Furthermore, thicknesses of the dielectric layers can be smaller than 20 μm and more preferably smaller than 10 μm. The dielectric layers is manufactured by one material, such as polyimide and formed by a coating method. Significantly, the positions of the metal in the first metal layer are corresponding to the positions of the metal in the second metal layer and the redundant metal with the central plane as a reference plane. The second metal layer, the redundant metal and the first metal layer are symmetrical with respect to the reference plane.

### BRIEF DESCRIPTION OF THE DRAWINGS

FIG. 1 depicts a diagram of a IC packaged with a PCB with a multi-layer substrate of the present invention in between.

FIG. 2 depicts a diagram of a first embodiment to decrease warpage of a multi-layer substrate according to the present invention.

FIG. 3 depicts a diagram of a second embodiment to decrease warpage of a multi-layer substrate according to the present invention.

FIG. 4 depicts a diagram of a third embodiment to decrease warpage of a multi-layer substrate according to the present invention.

FIG. 5 depicts a diagram of a fourth embodiment to decrease warpage of a multi-layer substrate according to the present invention.

FIG. 6 depicts a diagram of a fifth embodiment to decrease warpage of a multi-layer substrate according to the present invention.

### DETAILED DESCRIPTION OF THE INVENTION

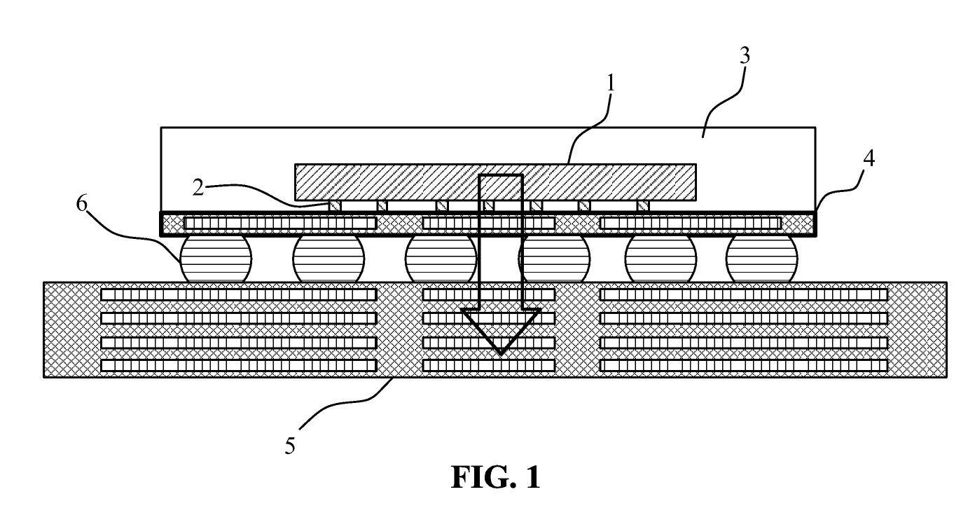

Please refer to FIG. 1, which depicts a diagram of a IC chip packaged with a print circuit board with a multi-layer substrate of the present invention in between. First, a semiconductor die 1 of the IC chip is packaged with a multi-layer substrate 4 of the present invention by micro-bumps 3 under the semiconductor die 1 and full-packaged by molding compound 3 to complete the BGA package for the IC chip. Then, the packaged IC chip is packaged on a print circuit board (PCB) 5 with solder balls 6 to finish a well known electronics product package structure. The multi-layer substrate 4 comprises a plurality of metal layers and a plurality of dielectric layers, which are alternately formed. The dielectric layers of the multi-layer substrate 4 can be formed by one material, such as polyimide. The details of the multi-layer substrate 4 will be introduced later. As aforementioned for the mobile electronics devices in prior art, no fans even no heat dissipation module can be installed and for the portability, the thermal flux is conducted mainly through the multi-layer substrate 4 of the present invention to the print circuit board (PCB) 5 and the direction of the thermal flux of the semiconductor die 1 is indicated by the arrow shown in FIG. 1.

In a case that the thermal flux density of the semiconductor die 1 having 10 W/cm² is illustrated, and the most dielectric layers of the multi-layer substrate 4 are formed by polyimide, which the conductivity k is 0.1 W/m·C. If the thickness of the polyimide layers is 10 μm, the surface temperature of the semiconductor die 1 can be 10° C. higher than the external environment. However, if the dielectric layers are formed by 50% copper and 50% polyimide ratio, the temperature difference between the surface temperature of the semiconductor die 1 and the external environment can be dropped down to 5° C. because the heat dissipation efficiency of the multi-layer substrate 4 is dramatically promoted. Practically, the work temperature of a general semiconductor die 1 is equal or smaller than 85° C. and the multi-layer substrate 4 has four dielectric layers as an illustration. If the dielectric layers of the multi-layer substrate 4 are formed by about 50% redundant copper and 50% polyimide ratio. The temperature difference between the surface temperature of the semiconductor die 1 and the external environment can be dropped down from 40° C. to 20° C. Significantly, for considering the trend of continuous miniaturization for all electronics products, the multi-layer substrate 4 with higher and better heat dissipation efficiency becomes unavoidably needed which can be satisfied by the present invention.

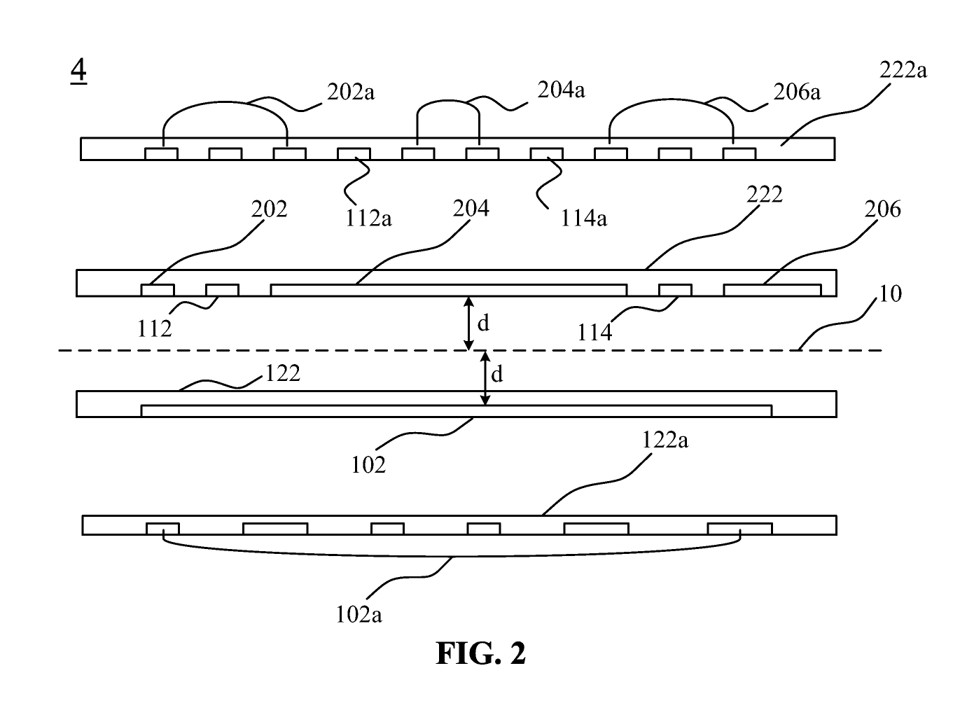

Please refer to FIG. 2, which depicts a diagram of a first embodiment to decrease warpage of a multi-layer substrate 4 according to the present invention. The multi-layer substrate comprises a first metal layer 102, a first dielectric layer 122 corresponding thereto, second metal layers 112, 114 and a second dielectric layer 222 corresponding thereto. The metal layers 102, 112, 114 and the dielectric layers 122, 222 are alternately stacked-up and formed. As shown in FIG. 2, a plane parallel with a first metal layer 102 and a second metal layer 112, 114 of the plurality of metal layers is shown. The plane is defined as a hypothetical central plane 10 between the first metal layer 102 and the second metal layer 112, 114. The hypothetical central plane 10 is parallel with the first metal layer 102 and a second metal layer 112, 114 and substantially has the same distance d between the first metal layer 102 and the second metal layer 112, 114 respectively.

Moreover, the dielectric layers 122, 222 in the multi-layer substrate can be manufactured by one material, i.e. the material of the dielectric layers 122, 222 can be same, such as PI (polyimide). The coating method can be illustrated for forming the dielectric layers 122, 222. Specifically, with coating method, one single layer thickness of the multi-layer substrate can reach below 20 μm or even 10 μm. The total thickness of an 8-layer substrate product can be about 80˜90 μm, and even thinner. The thicknesses of the dielectric layers 122, 222 formed by the coating method can be smaller than 20 μm and even smaller than 10 μm for forming a multi-layer substrate structure applicable to a flexible multi-layer substrate. In the flexible multi-layer substrate with such dimension, the unbalanced stress caused by the different volumes, thicknesses, materials, or constructions of different metal layers and dielectric layers can be more serious.

As aforementioned, the first dielectric layer 122 and the second dielectric layer 222 are formed by a coating method. As the aforesaid drying and hardening process is proceeded, and shrinkage rates of respective dielectric layers may be different. Stresses in the multi-layer substrate become unbalanced between some metal layers and dielectric layers to result in warpage. Moreover, even the dielectric layers are not formed by the coating method, unbalanced stress between the metal layers and dielectric layers of the multi-layer substrate causes warpage thereof due to different volumes, thicknesses, materials, or constructions of different metal layers and dielectric layers. Therefore, the present invention can be employed to homogenize the stresses in the multi-layer structure, which is composed of different metal layers and dielectric layers as shown in FIG. 2. Particularly, the stresses caused by differences of the occupied area and the location of different metal layers and dielectric layers in the multi-layer structure can be decreased.

As sown in FIG. 2, the first metal layer 102 covers and occupies most area of the multi-layer substrate. A first total area of the metal in the first metal layer 102 is larger than a second area covered and occupied by the metal in the second metal layers 112 and 114. Therefore, in the same layer of the second metal layers 112 and 114, redundant metal 202, 204 and 206 can be set on the premise that circuit design is not affected. The total second area comprising the second area and a redundant metal area covered by the redundant metal is considerably equivalent to the first total area. Moreover, the positions of the redundant metal 202, 204 and 206 and the metal in the second metal layer 112, 114 are corresponding to the positions of the metal in the first metal layer 102 with the hypothetical central plane 10 as a reference plane. Accordingly, stress in the multi-layer substrate caused by the first metal layer 102 and the second metal layer 112, 114 can be balanced to prevent warpage.

As shown in FIG. 2, the multi-layer substrate may further comprise a fourth metal layer 102a, a fourth dielectric layer 122a corresponding thereto, fifth metal layers 112a, 114a and fifth dielectric layer 222a corresponding thereto. The fourth metal layer 102a is located at outer side of the first metal layer 102; the fifth metal layers 112a, 114a are located at outer side of the second metal layers 112 and 114. Similarly, the material of the dielectric layers 122a, 222a can be same, such as PI (polyimide). The coating method can be illustrated for forming the dielectric layers 122a, 222a. Specifically, the thicknesses of the dielectric layers 122a, 222a formed by the coating method can be smaller than 20 μm and even smaller than 10 μm for forming a multi-layer substrate structure applicable to a flexible multi-layer substrate. As fourth total area covered by the metal in the fourth metal layer 102a is larger than a fifth area covered and occupied by the metal in the fifth metal layers 112a, 114a. Similarly as described as aforementioned, fifth redundant metal 202a, 204a and 206a can be set in the same layer of the fifth metal layers 112a, 114a on the premise that circuit design is not affected. The total fifth area comprising the fifth area and a redundant metal area covered by the fifth redundant metal 202a, 204a and 206a is considerably equivalent to the fourth total area. Moreover, positions of the fifth redundant metal 202a, 204a and 206a and the metal in the fifth metal layers 112a, 114a are corresponding to the positions of the metal in the fourth metal layer 102a with the hypothetical central plane 10 as a reference plane. Accordingly, the stress in the multi-layer substrate caused by the fourth metal layer 102a and the fifth metal layers 112a, 114a can be balanced to prevent warpage.

With overall consideration for the multi-layer substrate, no matter the two metal layers positioned corresponding to each other are adjacent with each other or not, making the interior of the multi-layer substrate as symmetrical structures with the hypothetical central plane 10 as a reference plane described as the first metal layer 102 and the second metal layer 112, 114; as the fourth metal layer 102a and the fifth metal layers 112a, 114a, stresses in the multi-layer substrate can be balanced to decrease warpage thereof. Alternatively, as the fourth metal layer 102a is located at inner side of the first metal layer 102; the fifth metal layers 112a, 114a are located at inner side of the second metal layers 112 and 114, the present invention can still work for balancing stress in the multi-layer substrate, therefore, decreasing warpage of the multi-layer substrate.

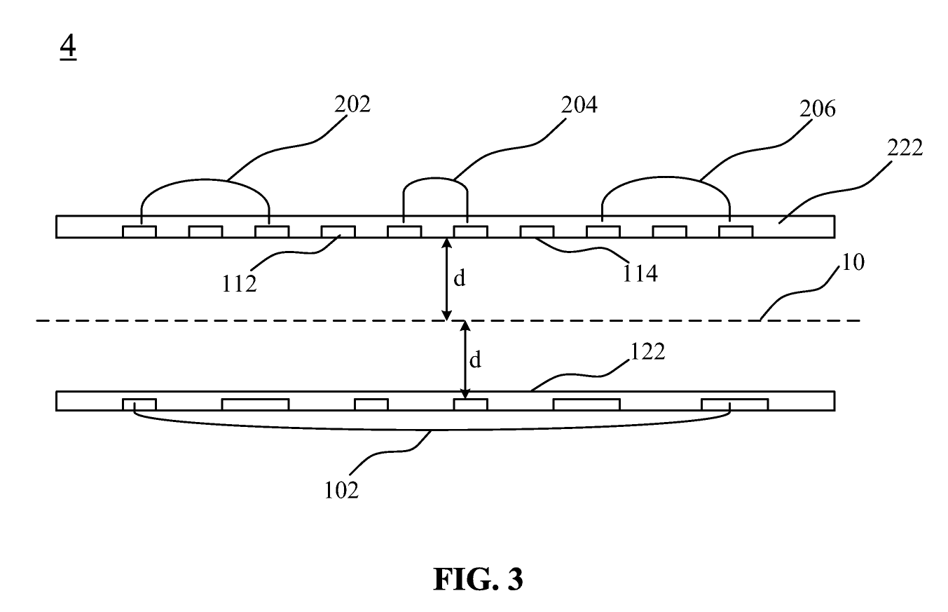

Please refer to FIG. 3, which depicts a diagram of a second embodiment to decrease warpage of a multi-layer substrate 4 according to the present invention. The multi-layer substrate comprises a first metal layer 102, a first dielectric layer 122 corresponding thereto, second metal layers 112, 114 and a second dielectric layer 222 corresponding thereto.

In this embodiment, pattern of the first metal layer 102 is complex but a first total area covered and occupied by the metal in the first metal layer 102 is still larger than a second area of the second metal layers 112, 114. Therefore, in the same layer of the second metal layers 112 and 114, small, distributed redundant metal 202, 204 and 206 can be set on the premise that circuit design is not affected. The total second area comprising the second area and a redundant metal area covered by the redundant metal 202, 204 and 206 is considerably equivalent to the first total area. Moreover, positions of the redundant metal 202, 204 and 206 and the metal in the second metal layer 112, 114 are corresponding to the positions of the metal in the first metal layer 102 with the hypothetical central plane 10 as a reference plane. Accordingly, stress in the multi-layer substrate caused by the first metal layer 102 and the second metal layer 112, 114 can be balanced to decrease warpage.

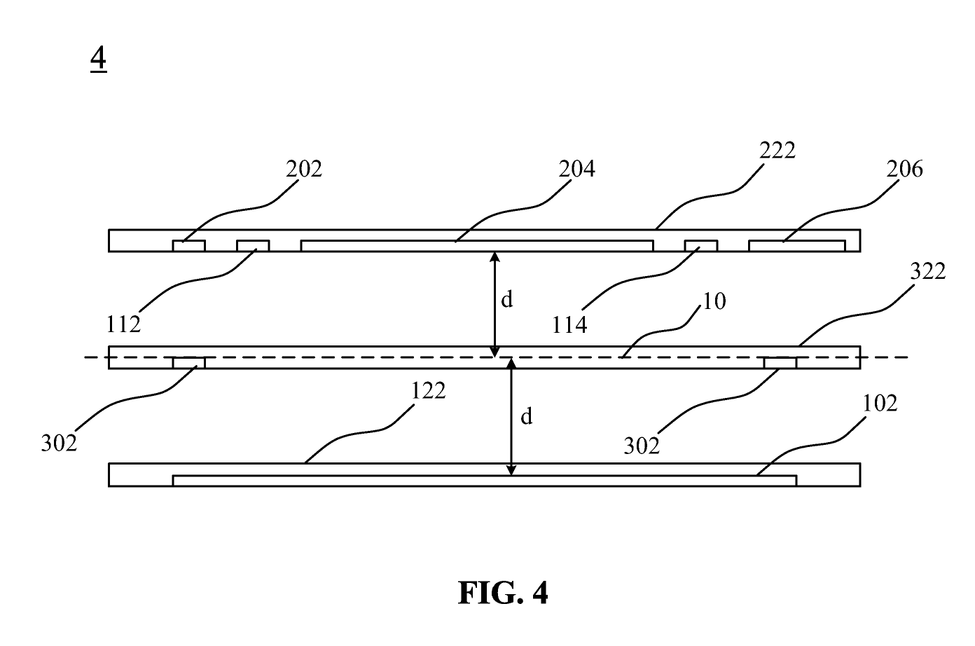

Please refer to FIG. 4, which depicts a diagram of a third embodiment to decrease warpage of a multi-layer 4 substrate according to the present invention. The multi-layer substrate comprises a first metal layer 102, a first dielectric layer 122 corresponding thereto, second metal layers 112, 114 and a second dielectric layer 222 corresponding thereto. As shown in FIG. 4, a plane parallel with a first metal layer 102 and a second metal layer 112 of the plurality of metal layers is shown. The plane is defined as a hypothetical central plane 10 between the first metal layer 102 and the second metal layer 112, 114. The hypothetical central plane 10 is parallel with the first metal layer 102 and a second metal layer 112, 114.

Furthermore, the multi-layer substrate can further comprise a third metal layer 302. As shown in FIG. 4, the plane in the third metal layer 302 is defined as a hypothetical central plane 10 between the first metal layer 102 and the second metal layers 112, 114. The hypothetical central plane 10 substantially has the same distance d between the first metal layer 112 and the second metal layer 114 respectively. A first total area of the third metal layer 302 can be smaller than both a first total area covered by the metal in the first metal layer 102 and a second area covered by the metal in the second metal layers 112, 114. Therefore, consideration of area of the third metal layer 302 therebetween can be ignored but only the covered areas and covered locations differences between the first metal layer 102 and the second metal layers 112, 114.

Moreover, the dielectric layers 122, 222 in the multi-layer substrate can be manufactured by one material, i.e. the material of the dielectric layers 122, 222 can be the same, such as PI (polyimide). The coating method can be illustrated for forming the dielectric layers 122, 222. Specifically, the thicknesses of the dielectric layers 122, 222 formed by the coating method can be smaller than 20 μm and even smaller than 10 μm for forming a multi-layer substrate structure applicable to a flexible multi-layer substrate.

As aforementioned, for making the interior of the multi-layer substrate as symmetrical structures with overall considering the multi-layer substrate, therefore, the present invention can set smaller redundant metal layers 202, 206 and a larger redundant metal layer 204 in the same layer of the second metal layers 112 and 114 on the premise that circuit design is not affected. The total second area comprising the second area and a redundant metal area covered by the redundant metal 202, 204 and 206 is considerably equivalent to the first total area. Moreover, positions of the redundant metal 202, 204 and 206 and the metal in the second metal layer 112, 114 are corresponding to the positions of the metal in the first metal layer 102 with the hypothetical central plane 10 as a reference plane. Accordingly, stress in the multi-layer substrate caused by the first metal layer 102 and the second metal layer 112, 114 can be balanced to prevent warpage.

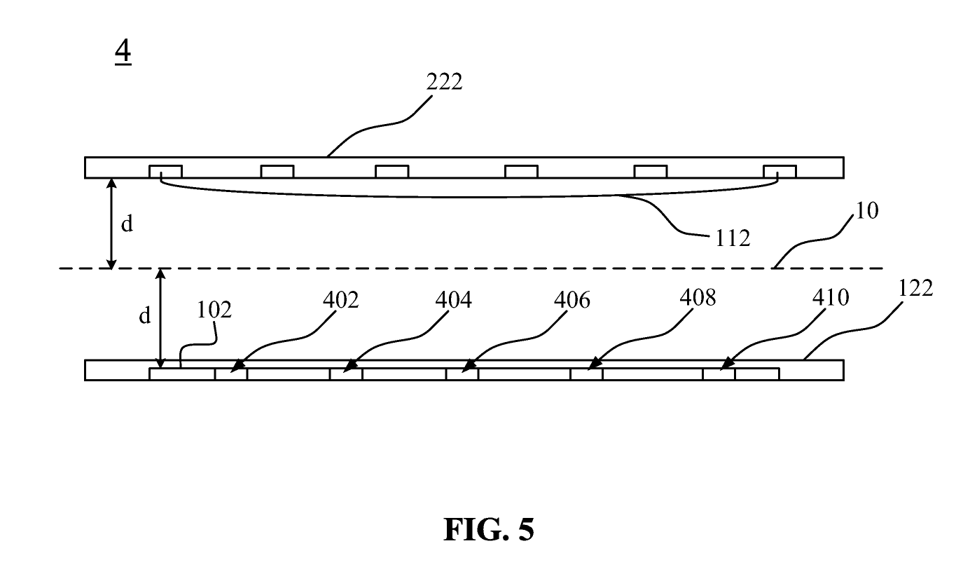

Please refer to FIG. 5, which depicts a diagram of a fourth embodiment to decrease warpage of a multi-layer substrate 4 according to the present invention. The multi-layer substrate comprises a first metal layer 102, a first dielectric layer 122 corresponding thereto, second metal layers 112, 114 and a second dielectric layer 222 corresponding thereto. The metal layers 112 and the dielectric layers 122, 222 are alternately stacked-up and formed. As shown in FIG. 5, a plane parallel with a first metal layer 102 and a second metal layer 112 of the plurality of metal layers is shown. The plane is defined as a hypothetical central plane 10 between the first metal layer 102 and the second metal layer 112. The hypothetical central plane 10 is parallel with the first metal layer 102 and a second metal layer 112 and substantially has the same distance d between the first metal layer 102 and the second metal layer 112 respectively.

Moreover, the dielectric layers 122, 222 in the multi-layer substrate can be manufactured by one material, i.e. the material of the dielectric layers 122, 222 can be the same, such as PI (polyimide). The coating method can be illustrated for forming the dielectric layers 122, 222. Specifically, the thicknesses of the dielectric layers 122, 222 formed by the coating method can be smaller than 20 μm and even smaller than 10 μm for forming a multi-layer substrate structure applicable to a flexible multi-layer substrate.

A first total area covered by the metal in the first metal layer 102 is larger than a second area of the second metal layer 112. However, what is different from the aforesaid embodiments is that redundant spaces 402, 404, 406, 408 and 410 can be set in the first metal layer 102 so that a first total area covered by the metal in the first metal layer 102 subtracting redundant space areas is considerably equivalent to the a second total area covered by the metal in the second metal layers 112. Besides, positions of the first metal layer 102 subtracting redundant spaces are corresponding to positions of the second metal layer 112 with the hypothetical central plane 10 as a reference plane. Accordingly, balancing stress in the multi-layer substrate to decrease warpage thereof can be realized.

In this embodiment, certainly as similar as described in aforesaid embodiment, the multi-layer substrate may further comprise a fourth metal layer located at inner side or outer side of the of the first metal layer 102; and, the fifth metal layer located at inner side or outer side of the second metal layers 112. As the fourth metal layer is larger then the fifth metal layers. A fourth redundant space can be set in the fourth metal layer to make the interior of the multi-layer substrate as symmetrical structures. No matter corresponding metal layers are adjacent or not, stress in the multi-layer substrate can be balanced and warpage of the multi-layer substrate can be decreased.

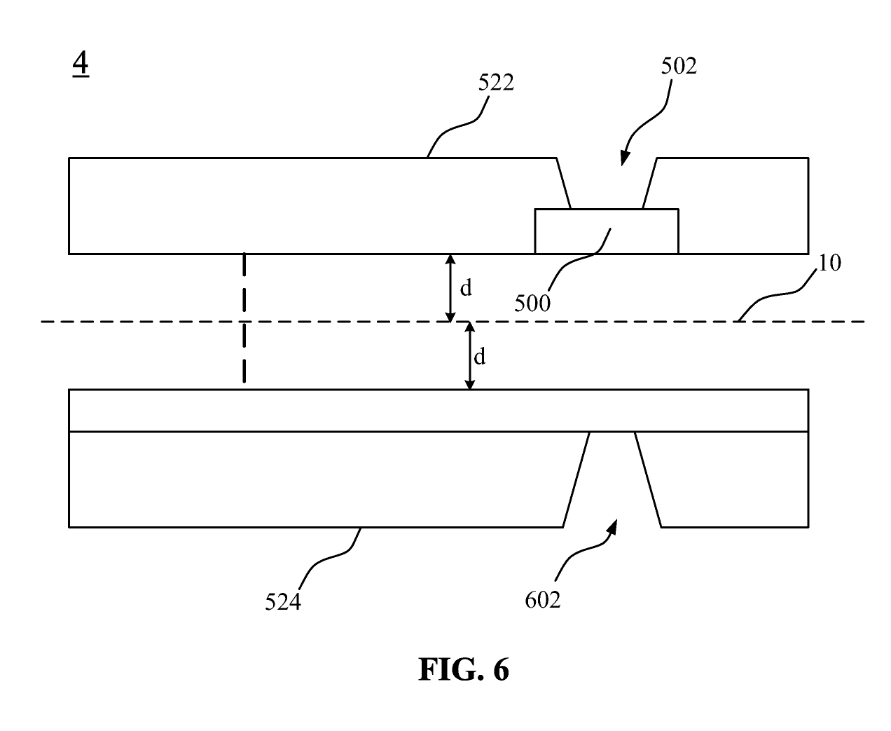

Please refer to FIG. 6, which depicts a diagram of a fifth embodiment to decrease warpage of a multi-layer substrate 4 according to the present invention. As shown in FIG. 6, the multi-layer substrate has an opening 502 in the first surface dielectric layer 522 located at a first surface of the multi-layer substrate at the position of a pad 500. The multi-layer substrate also has a second surface dielectric layer 524 located at a second surface of the multi-layer substrate. With concept of homogenize the multi-layer structure composed of different metal layers and dielectric layers according to the present invention, a redundant opening 602 can be set corresponding to the opening 502 positionally to balance stress in the multi-layer substrate to decrease warpage thereof. Similarly, if the opening 502 is in the interior of the multi-layer substrate, a redundant opening positioned corresponding to the opening 502 still can be set with overall considering the structure of the multi-layer substrate. The stress in the multi-layer substrate still can be balanced and decreasing warpage of the multi-layer substrate still can be realized.

In conclusion, the first to fifth embodiments can be exercised alone or in combination for matching different electric circuit designs when a multi-layer substrate is manufactured. Homogenization for occupied areas and locations of different metal layers and dielectric layers in the multi-layer substrate can be achieved to decrease warpage or twist of the multi-layer substrate.

In traditional PCB manufacture industry of prior art, which glass fabrics and copper foil are employed as manufacture elements, the thickness of the glass fabrics is about 100 μm and the thickness of the copper foil is about 30 μm. In the present invention, which the polyimide and copper are employed as being manufacture elements, the thickness of polyimide (one dielectric layer) is about 10 μm or less and the thickness of the copper is about 1˜10 μm, or more precisely about 3˜7 μm. Besides, the CTEs (Coefficient of thermal expansion) of the glass fabrics and polyimide are ten times different. Therefore, the warpages of the glass fabrics and polyimide can become even larger than ten times. With the aforesaid thickness and CTE differences from prior art in the dimension of the present invention, the thickness and the rigidity of the multi-layer substrate is smaller and the interior stress of the multi-layer substrate can be more obvious, the warpage effects more seriously without careful considerations. Under such circumstances, an extra carrier needs to be involved in all manufacture and the package processes of the multi-layer substrate. With the redundant metals and opens of the present invention, the extra carrier can be omitted.

Moreover, the process temperature of lamination for the glass fabrics of the traditional PCB is 100˜200° C. and the process temperature of the polyimide of the present invention is higher than 250° C. and even reaches 350° C. As mentioned in the aforementioned, the drying and hardening process are necessary for polyimide in the present invention, the drying temperature can be 100˜180° C. and hardening temperature can be 250˜350° C. The shrinkage rate of the dielectric layer (polyimide) of the multi-layer substrate is larger than 20% at least and may reach up to 50%. Therefore, without proper consideration for balancing stresses in the multi-layer substrate of the present invention, the multi-layer substrate may even crimp. The stress in the flexible multi-layer substrate of the present invention can be much higher than the traditional PCB lamination processes. Accordingly, the warpage can effect more seriously than prior art without careful considerations.

Significantly, the present invention can be applicable for a flexible multi-layer substrate. By adding redundant metals to the dielectric layers, the heat dissipation efficiency of the multi-layer substrate can be improved. More particularly, with overall consideration for adding redundant metals to the dielectric layers of the multi-layer substrate with a arbitrary hypothetical central plane inside the multi-layer substrate as a reference plane but not only surfaces of the multi-layer substrate are considered, the present invention can be applicable for a flexible multi-layer substrate in which the thicknesses of the dielectric layers are smaller than 20 μm and even smaller than 10 μm. Furthermore, the extra carrier of fixing and carrying the multi-layer substrate for all manufacture and the package processes also can be omitted and leads to simplification and more convenience to the whole processes. Time, material and manpower can be saved in advance.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A multi-layer substrate structure, comprising a plurality of metal layers and a plurality of dielectric layers, which are alternately formed in the multi-layer substrate structure, and a plane parallel with a first metal layer and a second metal layer of the plurality of metal layers substantially has the same distance between the first metal layer and the second metal layer respectively, and the plane is defined as a central plane between the first metal layer and the second metal layer, wherein a first total area covered by metal in the first metal layer is larger than a second area covered by metal in the second metal layer, wherein at least one redundant metal is further set in same layer of the second metal layer, and a second total area comprising a redundant metal area covered by the redundant metal and the second area, is considerably equivalent to the first total area.

2. The multi-layer substrate structure of claim 1, wherein the redundant metal is formed for improve a heat dissipation efficiency of the multi-layer substrate.

3. The multi-layer substrate structure of claim 1, wherein thicknesses of the dielectric layers are smaller than 20 μm.

4. The multi-layer substrate structure of claim 1, wherein thicknesses of the dielectric layers are smaller than 10 μm.

5. The multi-layer substrate structure of claim 1, wherein the first metal layer and the second metal layer are interior layers of the multi-layer substrate structure.

6. The multi-layer substrate structure of claim 1, wherein the dielectric layers are manufactured by one material.

7. The multi-layer substrate structure of claim 1, wherein the dielectric layers are formed by coating method.

8. The multi-layer substrate structure of claim 7, wherein the dielectric layers are dried with 100˜180° C. and cured with 250˜350° C. in the coating method.

9. The multi-layer substrate structure of claim 1, wherein thicknesses of the metal layers are 1-10 μm.

10. The multi-layer substrate structure of claim 1, wherein positions of the metal in the first metal layer are corresponding to positions of the metal in the second metal layer and the redundant metal with the central plane as a reference plane.

11. A multi-layer substrate structure, comprising a plurality of metal layers and a plurality of dielectric layers, which are alternately formed in the multi-layer substrate structure, and a plane parallel with a first metal layer and a second metal layer of the plurality of metal layers, and the plane is defined as a reference plane between the first metal layer and the second metal layer, wherein a first total area covered by metal in the first metal layer is larger than a second area covered by metal in the second metal layer, wherein at least one redundant metal is further set in same layer of the second metal layer, and a second total area comprising a redundant metal area covered by the redundant metal and the second area, is considerably equivalent to the first total area to form the second metal layer, the redundant metal and the first metal layer to be symmetrical with respect to the reference plane.

12. The multi-layer substrate structure of claim 11, wherein the redundant metal is formed to improve a heat dissipation efficiency of the multi-layer substrate.

13. The multi-layer substrate structure of claim 11, wherein the reference plane has the same distance between the first metal layer and the second metal layer respectively.

14. The multi-layer substrate structure of claim 11, wherein the dielectric layers are manufactured by one material.

15. The multi-layer substrate structure of claim 11, wherein thicknesses of the dielectric layers are smaller than 20 μm.

16. The multi-layer substrate structure of claim 11, wherein thicknesses of the dielectric layers are smaller than 10 μm.

17. The multi-layer substrate structure of claim 11, wherein the first metal layer and the second metal layer are interior layers of the multi-layer substrate structure.

18. The multi-layer substrate structure of claim 11, wherein the dielectric layers are formed by coating method.

19. The multi-layer substrate structure of claim 18, wherein the dielectric layers are dried with 100˜180° C. and cured with 250˜350° C. in the coating method.

20. The multi-layer substrate structure of claim 11, wherein thicknesses of the metal layers are 1˜10 μm.
